(19) United States
(12) Patent Application Publication
(10) Pub. No.: US 2003/0014347 A1
(43) Pub. Date: Jan. 16, 2003

(54) System for isolating clients and bidders in a multiple risk bid market

(76) Inventor: Natan Elazar Tiefenbrun, New York, NY (US)

Correspondence Address: FITZPATRICK CELLA HARPER & SCINTO, 30 ROCKEFELLER PLAZA, NEW YORK, NY, 10112, US

(21) Appl. No.: 09/903,674

(22) Filed: Jul. 13, 2001

(51) Int. Cl. G06F 17/60

(52) U.S. Cl. 705/37; 705/36

(57) ABSTRACT

The present invention relates to a risk bid market system which eliminates the potential for front running and information leakage. This system includes a computer system for hosting software bidding modules, each bidding module maintained by a bidder. The system also includes a interface through which a client submits information to the computer regarding a portfolio or a block order. The system further includes a communication link for communicating in real time data from the plurality of bidders to their respective bidding modules. The information provided by the client to the computer cannot be communicated to the bidders through the communication means, thereby isolating that information from the bidders.

### BACKGROUND OF THE INVENTION

1. Field of the Invention

The present invention relates to the field of risk bid solicitation. In particular, the present invention relates to a system for allowing a client to solicit and receive multiple risk bids from different bidders for the execution of a portfolio or block order on an immediate principal basis or a forward price (guaranteed benchmark) basis, and to execute the portfolio or block order against the best received bid.

2. Related Background Art

One common trading situation is a client that wishes to sell or buy a large portfolio of securities, such as stocks, etc. For example, if the portfolio is executed on an agency basis, the stocks will likely be sold and bought over time in piecemeal (100 shares to party A, 500 shares to party B, 300 shares to party C). This technique for executing the client's position has its drawbacks. Market prices may move for or against the client prior to or during trading, with the possible result being a poorer overall execution price (higher purchase price or lower selling price) for the client, as the execution of the trades over a period of time exposes the client to market risk.

To overcome these problems, a risk bid may be obtained by the client, in which a bidder (usually a broker) guarantees the client for the portfolio either a known price, or a price that can be determined at a specific point in time (for example, the “Last” price prevailing in an open market, the VWAP, short for volume weighted average price, or the “Close” price). The bidder then assumes the market risk as the portfolio is unwound. For assuming this risk and unwinding the portfolio, the broker charges the client a commission/premium.

In conventional risk bid soliciting, a client seeks a commitment of capital against its order flow. In particular, the client solicits from a bidder a risk bid for the execution of its portfolios or block orders, on either an immediate principal basis or a forward price (guaranteed benchmark) basis. As stated above, the risk bid is the price a bidder will charge to guarantee the client the execution of a portfolio or block order at a particular price. If the client accepts this guaranteed price from the bidder, then the bidder assumes all of the positions in the portfolio or block order, and assumes the risks associating with unwinding the same, such as the impact of execution on market prices and the risk of price movements prior to execution (market risk). The client usually solicits and receives bids from multiple bidders, and then accepts the best received bid.

When conventionally soliciting a risk bid, the client must reveal sufficient information about the portfolio/block to each bidder to allow the bidder to assess the inherent risk in executing the trade and adopting the positions in consideration of what price to quote to the client. This typically involves the client supplying “portfolio characteristics” to the bidder which are then used by the bidder to quantify approximately the risk. The more explicit the information the client supplies, the more accurately the risk can be assessed by the bidder, and thus, the more efficient the market and the more competitive the bidding process should be. This in turn should result in a lower risk premium/commission charged by the bidder.

However, clients are reluctant to reveal too much information about the trade because it may allow the bidders to improperly use this information to trade against, or “front run,” the client's order. Front running can adversely impact market prices before the market risk has been fully transferred to the broker. For example, a broker bidding on or having won a portfolio for which the price is not yet fully known, and thus having knowledge that the client has a substantial stock to buy, may buy some stock for his own account in anticipation of the market prices rising. The broker's participation in the market for his own account will drive prices higher, adversely affecting the prices ultimately received by the client.

Thus, a bidder can try to benefit from the price movements that the execution of the client's portfolio will likely cause. This in turn will result in a poorer price that could otherwise be obtained when the order is executed. Clients and bidders are most nervous about front running done by losing bidders, i.e., those bidders who did not ultimately receive the client's orders to execute, who, unlike the winning bidder, have no further obligation of fair dealing to the client. The more sophisticated (ultimate) losing bidders can deduce enough information from a potential client's portfolio characteristics to allow them to front run successfully.

Clients may also be reluctant to disclose too much information to the bidders because it may reveal proprietary information about the client's investment strategy.

Accordingly, there is a trade-off between the costs of disclosing too much information to the bidders (increased chance of front running and revelation of proprietary trading strategy) and providing too little information to the bidders (reduction of market efficiency and increased risk premium). That is, if not for the fear of front running and the potential revelation of strategy, the client would supply enough information to the bidders to create an efficient market.

In addition, if the market was efficient, the participation of more bidders would lead to more competitive bidding. However, in current practice, the participation of more bidders will lead to more information leakage and more potential for front running. In particular, when a bidder responds to a solicitation for a bid, it often asks the client how many other bids have been solicited. This is because the bidder is reluctant to win a portfolio/block order (and thereby assume the associated risk of unwinding the portfolio/block order's position) if there will be many losing bidders, all or any of whom might be front running before the winning bidder can hedge or unwind the position. Thus, the bidder is disinclined to make a competitive bid if there are, in its opinion, too many other bidders. This results in bidders charging a higher premium (to compensate for the risk of front running), or too few bidders to drive real competition. For example, as few as two to four bidders may bid, typically resulting in a less competitive bid for the client's order.

The potential for front running may be exacerbated by the direct (non-anonymous) contact between the client and bidder in the bid solicitation process. Because the bidder knows who the client is, the bidder also knows the client's previous trades and investment style, which, in addition to the other client-supplied information, may be used to even more effectively anticipate the details of the client's orders and front run the client's order. To reduce this problem, an electronic bidding system has been proposed by Plexus in which a client solicits bids on an anonymous basis through a “portal.” The client's identity is only revealed after it accepts the winning bid.

However, this system has two drawbacks. First, while it may reduce the impact of the bidders' knowledge of the client's identity on front running, it does not eliminate the potential for front running altogether, because bidders may front run using the portfolio characteristics supplied by the portal in relation to the client's portfolio. Further, knowledge of the client's identity is important to the bidders, because bidders can incorporate their knowledge of the client's previous trades to better quantify their risk, which can in turn result in lower risk premiums and thus more competitive bids. This is especially true because the bidders rely on only general trade characteristics to assess risk. Thus, a system in which the client remains anonymous until after the bids have been accepted but which also relies upon the client's portfolio characteristics for bidding may still result in (a) front running and thus less competitive bidding, and (b) an inefficient assessment of risk leading to a higher risk premium/commission being charged.

In view of the above concerns, there is a need in the art for a system that creates a risk bid market in which improper information leakage and front running are eliminated. This system must eliminate front running by all bidders, regardless of whether they win or lose. Without the potential of front running, bidders would not object to a client soliciting as many bids as possible, and thus the system would enable sufficient bidding competition to assure the client of the most competitive price possible. Additionally, the client would not object to supplying the bidders highly detailed information regarding the order (e.g., the portfolio itself), rather than the few generalized trading characteristics as is common today. This in turn would permit the bidders to more efficiently and accurately assess their risk and set their bid prices and risk premiums/commissions more efficiently and competitively.

Moreover, there would be no negative consequences of client anonymity in the solicitation process, because the highly detailed trade information provided by the client would allow the bidders to quantify risk with sufficient accuracy, without the need to use the client's past trading history. Consequently, the system can operate anonymously, both before and after execution, thereby allowing a client to keep to itself information about its investment strategy.

### SUMMARY OF THE INVENTION

To overcome the above-described limitations in the art, the present invention relates to a system that, in various embodiments:

(1) eliminates the market impact associated with soliciting bids for portfolios and block orders caused by front running by eliminating all possibility of information leakage to the bidders;

(2) allows for a more accurate assessment of risk than afforded by the current risk bid market; and

(3) introduces anonymity (from the solicitation of bids through the execution of portfolios and block orders).

In the system and method of the present invention, the information regarding the client's portfolios can not reach the bidders because they are isolated from their respective bidding modules. Information leakage and front running typically associated with the conventional solicitation and execution of risk bids are thereby prevented. In addition, the client's identity is kept anonymous, thereby allowing a client to keep from the bidders information about its investment strategy.

In one aspect of the present invention, a system for creating a risk bid market system are provided. The system may include a computer system for hosting a plurality of software bidding modules respectively corresponding to a plurality of bidders, an interface through which a client submits information into the computer system (such as portfolio or block order information), and means for communicating in real time data from the plurality of bidders to their respective bidding modules. The information provided by the client for the purpose of soliciting a bid cannot be communicated to the bidders through the communication means. The system may further include a gateway/bid processor through which the client and winning bidder are notified of the execution of the trade.

In another aspect of the present invention, a method for creating a risk bid market is provided. This method includes the steps of (1) hosting in a computer system a plurality of software bidding modules respectively corresponding to a plurality of bidders, (2) through a communication link, supplying real-time data by the plurality of bidders to their respective bidding modules to maintain the same, and (3) providing portfolio or block order information by the client to the bidding modules to obtain a bid from the same, wherein the client-provided information cannot be communicated to the bidders through the communication link.

The above system and method isolate the client information from the bidders, preventing information leakage and front running.

### BRIEF DESCRIPTION OF THE DRAWINGS

FIG. 1 is a block diagram relating to the system and method of the present invention.

FIG. 2 is a chart showing the flow of information in the system and method of the present invention.

### DETAILED DESCRIPTION OF THE PREFERRED EMBODIMENTS

The present invention relates to a system and method for implementing a risk bid market in which bidders are required to bid on portfolios (or block trades) in complete isolation from their personnel and internal financial systems. Because the bidder's personnel and financial systems are isolated from the system of the present invention, they are also isolated from any portfolio information supplied by the client in the solicitation process. Further, the solicitation process is conducted anonymously. Because neither the client supplied information nor its identity can be obtained through the system by a bidder's personnel or financial systems, a bidder cannot front run the client's order or build up a picture of the client's investment style.

The requirement of complete isolation further necessitates that the bidding process be completely quantitative and fully automated, because any intervention by the bidder's personnel, or by its financial systems, might lead to information leakage, and front running. Full automation is also required to ensure that all of the bids are received and compared in a timely fashion. In essence, the system acts as a fully automated proxy for the bidders.

Further, to guarantee complete anonymity between the client and the bidders during the bidding process and after trade execution, a neutral third party is required to operate the system, and to act as a clearing and settlement counterparty to both the client and the winning bidder. Because a neutral third party acts as a counterparty to both sides of the transactions, the third party can effectively compete for the execution of the portfolios and block orders on a principal basis without any risk to its own capital.

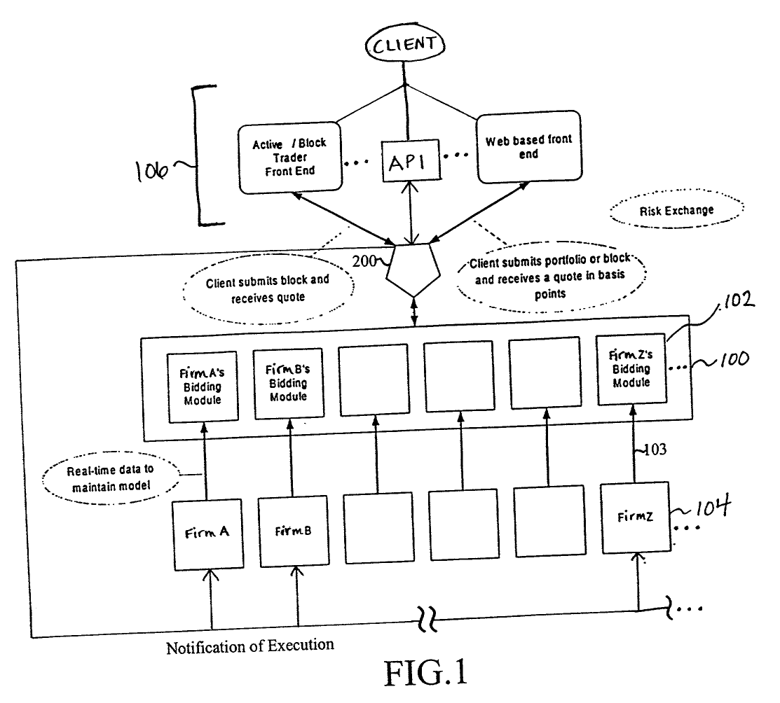

As shown in FIG. 1, in one embodiment of the present invention, a risk bid market system includes computer system 100, maintained by the third party or an appointed agent, which hosts a plurality of software bidding modules 102 respectively corresponding to a plurality of bidders. The bidders maintain their respective bidding modules 102 in isolation from their personnel and their other financial systems. Each bidder's modules are also isolated from the modules of other bidders. In this system, the bidders 104 maintain their bidding modules 102 by feeding them in real time with market data and other financial data (such as inventory, risk measures, etc.), so that the bidding modules can bid upon incoming portfolios or block orders in real time without requiring further input. A bidder may restrict the categories in which its bidding module 102 may provide bids. Further, a bidder may elect to maintain multiple bidding modules within the computer system 100.

A client submits a portfolio or a block order through the interface 106, which may include an active/block trader interface, an API (application interface), a web-based interface, or as will be appreciated by those skilled in the art, any other graphical-based or computer interface. After the portfolio/block order has been uploaded through the interface 106, it is validated by a gateway/bid processor 200 (which connects to the various interfaces and to the computer system 100, and communicates information therebetween) and passed to the computer system 100. After validation has occurred, the client can request solicitation of bids, for example, by the press of a software button.

On receiving a portfolio or block order from a client through a system interface 106 and a gateway/bid processor 200, the full details of the portfolio or block order are simultaneously passed to the various bidding modules 102 within the computer system 100. The simultaneous transmission of this client information to the bidding modules 102 ensures that all of the modules receive the portfolio or block order and construct the bids under identical or near-identical market conditions.

Importantly, the communication of real-time data to the respective bidding modules from the bidders is through communication links 103. Importantly, the protocol of the communication links 103 prevents all information from the bidding modules 102 about the client's portfolio or block order from being passed back to the bidders 104 through the communication links 103. Note, however, that the communication links 103 may be two-way, for example, well known bidirectional communication links. Also note that the communication protocol may permit information other than that concerning the client's portfolio or block order to be passed from the bidding module to the bidder.

The bidding modules 102 respond to the incoming portfolios or block orders within a specified time limit (which can vary, but is likely to be specified to be between 30 and 60 seconds). The following categories of bids may be made (this list does not limit the categories of bids):

(1) For an immediate principal execution of a portfolio: a quote in basis points away from the Last or Market price in the market (e.g., per consideration, per order, per share, per portfolio);

(2) For a guaranteed VWAP until the close for a portfolio or block order: a quote in basis points (e.g., per consideration, per order, per share, per portfolio);

(3) For a guaranteed future price, such as the closing price, or the Last or Market price at some future point in time: a quote in basis points (e.g., per consideration, per order, per share, per portfolio); and

(4) For an immediate principal execution of a block order: the net price (including commission) for the execution of the block order.

It is possible that, at times, a bidding module does not supply a bid. This can occur for a variety of reasons, such as the nature of the portfolio, the risk constraints within which it operates, technical failure between the bidder and the system, etc.

After the time for bidding has expired, the computer system 100 collates the bids supplied by each of the bidding modules 102, and presents the bids to the client through the gateway/bid processor 200 and interface 106, for example, in an order of competitiveness or in an order specified by the client. The client then has a short period of time (for example, one minute) during which it can accept a bid. After the time limit expires, the bids expire. These bids may also be made and accepted on a category-by-category basis.

The gateway/bid processor 200 and interface 106 may also be used to transmit price estimates to the client from another financial software system, such as one that performs agency execution of the portfolio. Those price estimates may be displayed with the bids received from the bidding modules 102. In this case, the client may then accept a bid, let all the bids expire by non-action, or request agency execution by the other financial system.

Once the bid is accepted, both the client and the winning bidder are notified of their respective executions by the computer system 100 through the gateway/bid processor 200, or the commitment by the winning bidder to execute the trade in the future (i.e., a forward price trade). For an immediate principal execution of portfolios or block orders, both the client and winning bidder may receive execution confirmation for every security in the portfolio, including price and commission. For a forward price trade (guaranteed benchmark trade), the client may receive a preliminary report specifying the quantity of each security executed, but not the price thereof, while the winning bidder may receive a preliminary report indicating the portfolio characteristics or the individual positions, or some combination thereof.

In particular, after the client accepts a bid, the bidder is notified by the gateway/bid processor 200 of the acceptance of the bid. Since the final price may not yet be determined, the client is first given a preliminary notification of execution of the bid by the gateway/bid processor 200. When the gateway/bid processor 200 determines the final price of the bid, it sends the client and bidder a final notification of execution of the portfolio.

At minimum, no information about the portfolio or block order is released from the system until the winning bidder and client have been notified of the execution thereof. However, it is possible that no information will ever be disclosed other than confirmation of the execution of the trade to the client and winning bidder. The bidders thus have zero visibility until the deal is done. Consequently, the client can fully disclose, without any fear of information leakage and front running, all information regarding the portfolio or block order.

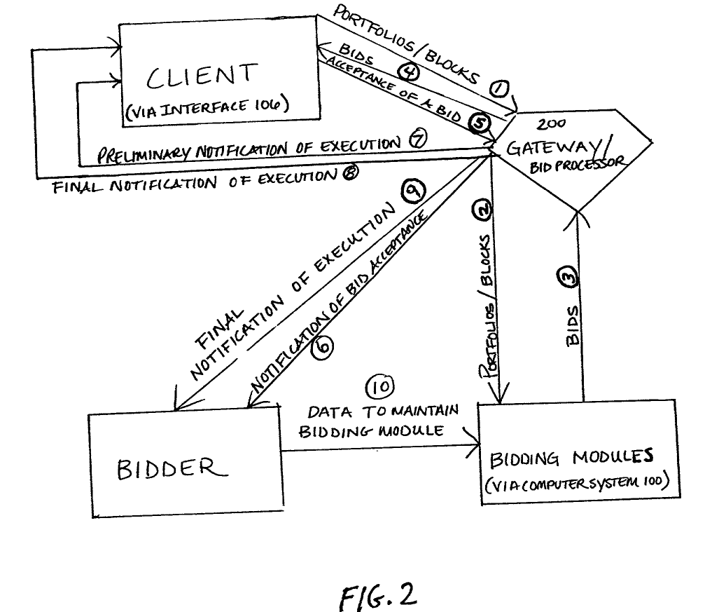

FIG. 2 is a chart summarizing the information flow between the client, bidding modules and bidders in the system and method described above. The client provides portfolio or block trade information to the gateway/bid processor 200 (1), which in turn passes it to the bidding modules (2). The bidding modules provide bids to the gateway/bid processor 200 (3), which in turn passes it back to the client (4). The acceptance of one of the bids is passed from the client to the gateway/bid processor 200 (5), which in turn notifies the bidder of the acceptance of the bid (6). The client receives a preliminary notification of execution of the trade (7). Upon a determination of final prices by the gateway/bid processor 200, it sends the client (8) and bidder (9) a final notification of execution. The bidders pass data to the bidding modules to maintain the same through the communication links 103 (10).

While the present invention has been described in detail with reference to the preferred embodiments thereof, many modifications and variations thereof will be readily apparent to those skilled in the art. Accordingly, the scope of the invention is not to be limited by the details of the preferred embodiments described above, but only by the terms of the appended claims.

What is claimed is:

1. A risk bid market system, comprising:
a computer system for hosting a plurality of software bidding modules respectively corresponding to a plurality of bidders;
an interface through which a client submits information to the computer system; and
communication means, for communicating in real time data, from the plurality of bidders to their respective bidding modules, wherein the information provided by the client to the computer system cannot be communicated to the bidders through the communication means.

2. A system according to claim 1, further comprising a gateway/bid processor between the interface and the computer system, through which the information is passed to either the client or bidders or both.

3. A system according to claim 2, wherein the gateway/bid processor notifies the client and one of the bidders of the execution of a trade.

4. A system according to claim 1, wherein the information comprises portfolio and block order information.

5. A system according to claim 1, wherein the information comprises bid information.

6. A system according to claim 1, wherein the information comprises bid acceptance information.

7. A risk bid market system, comprising:
a computer system for hosting a plurality of software bidding modules respectively corresponding to a plurality of bidders;
an interface through which a client submits information to the computer system; and
communication means, for communicating in real time data, from the plurality of bidders to their respective bidding modules, wherein the information provided by the client to the computer system cannot be communicated to the bidders through the communication means, and wherein the client remain anonymous from the bidders.

8. A method for creating a risk bid market, comprising the steps of:
hosting in a computer system a plurality of software bidding modules respectively corresponding to a plurality of bidders;
through a communication link, supplying real-time data by the plurality of bidders to their respective bidding modules to maintain the same; and
providing portfolio or block order information by the client to the bidding modules to obtain a bid from the same, wherein the client-provided information cannot be communicated to the bidders through the communication link.

9. A method for creating a risk bid market, comprising the steps of:
hosting in a computer system a plurality of software bidding modules respectively corresponding to a plurality of bidders;
through a communication link, supplying real-time data by the plurality of bidders to their respective bidding modules to maintain the same; and
providing portfolio or block order information by the client to the bidding modules to obtain a bid from the same, wherein the client-provided information cannot be communicated to the bidders through the communication link, and wherein the client remain anonymous from the bidders.
